(19) United States
(12) Patent Application Publication
(10) Pub. No.: US 2011/0202535 A1
(43) Pub. Date: Aug. 18, 2011

(54) SYSTEM AND METHOD FOR DETERMINING THE PROVENANCE OF A DOCUMENT

(76) Inventors: Vinay Deolalikar, Cupertino, CA (US); Hernan Laffitte, Mountain View, CA (US)

(21) Appl. No.: 12/705,584

(22) Filed: Feb. 13, 2010

(51) Int. Cl. G06F 17/30; G06F 3/048

(52) U.S. Cl. 707/739; 707/E17.008; 707/769; 707/752; 707/E17.089; 707/749; 715/810

(57) ABSTRACT

A method of identifying a provenance of a document is provided. The method may include obtaining a query document that is included in a document set comprising a plurality of documents. The method may also include grouping the plurality of documents into a plurality of fine clusters based on a textual similarity between the plurality of documents. The method may also include identifying a target fine cluster within the plurality of fine clusters, the target fine cluster including the query document. The method may also include ordering the documents included in the target fine cluster based, at least in part, on metadata associated with each of the documents to identify a source document. The method may also include generating a query response that includes the source document.

### BACKGROUND

Managing large numbers of electronic documents in a data storage system can present several challenges. A typical data storage system may store thousands of documents or more, many of which may be related in some way. For example, in some cases, a document may serve as a template which various people within the enterprise adapt to fit existing needs. In other cases, a document may be updated over time as new information is acquired or the current state of knowledge about a subject evolves. In some cases, several documents may relate to a common subject and may borrow text from common files. It may sometimes be useful to be able to trace the evolution of a stored document. For example, it may be useful to identify source documents that have contributed to the creation of the document. However, it will often be the case that the documents in the data storage system have been duplicated and edited over time without keeping any record of the version history of the document.

### BRIEF DESCRIPTION OF THE DRAWINGS

Certain exemplary embodiments are described in the following detailed description and in reference to the drawings, in which:

FIG. 1 is a block diagram of a computer network 100 in which a client system can access a document resource, in accordance with an exemplary embodiment of the present invention;

FIG. 2 is a process flow diagram of a method of determining the provenance of a document, in accordance with an exemplary embodiment of the present invention; and

FIG. 3 is a block diagram showing a tangible, machine-readable medium that stores code adapted to determine the provenance of a document, in accordance with an exemplary embodiment of the present invention.

### DETAILED DESCRIPTION

As used herein, the term “exemplary” merely denotes an example that may be useful for clarification of the present invention. The examples are not intended to limit the scope, as other techniques may be used while remaining within the scope of the present claims. Exemplary embodiments of the present invention provide techniques for determining the provenance of an electronic file, or “document,” referred to herein as a “query document.” As used herein, the “provenance” of the query document refers to the evolutionary chain of documents that lead to the creation of the query document. Each document in the evolutionary chain may be referred to as a “source” document. Each source document in the evolutionary chain may include textual subject matter that has been incorporated into the query document. For example, some source documents may be earlier versions of the query document, while other source documents may be documents from which text was copied and inserted into the query document. Still other source documents may be documents that discuss the same concepts as the query document and may have provided the author of the query document with a textual framework by which the query document was created.

To identify the provenance of a document, a user may select a query document from among a plurality of documents in a document set and initiate a provenance query to identify source documents in the document set based on the textual similarity of the source documents and the query document. Furthermore, the source documents in an evolutionary chain may be identified even if a record of the evolution of the documents has not been maintained. The earliest document in the evolutionary chain may be referred to as an “original document.” In some exemplary embodiments, source documents may be identified using a data mining technique known as “clustering.” Furthermore, to reduce the processing resources used to identify the source documents, a two-stage clustering algorithm may be used. As used herein, the term “automatically” is used to denote an automated process performed, for example, by a machine such as the computer device 102. It will be appreciated that various processing steps may be performed automatically even if not specifically referred to herein as such.

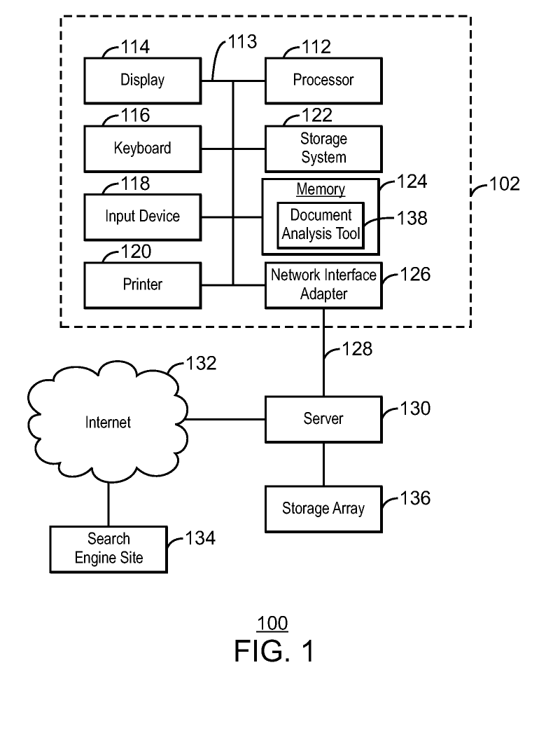

FIG. 1 is a block diagram of a computer network 100 in which a client system 102 can access a document resource, in accordance with an exemplary embodiment of the present invention. As used herein, the document resource may be any device or system that provides a collection of documents, for example, disk drive, storage array, an electronic mail server, search engine, and the like. As illustrated in FIG. 1, the client system 102 will generally have a processor 112, which may be connected through a bus 113 to a display 114, a keyboard 116, and one or more input devices 118, such as a mouse or touch screen. The client system 102 can also have an output device, such as a printer 120 operatively coupled to the bus 113.

The client system 102 can have other units operatively coupled to the processor 112 through the bus 113. These units can include tangible, machine-readable storage media, such as a storage system 122 for the long-term storage of operating programs and data, including the programs and data used in exemplary embodiments of the present techniques. The storage system 122 may include, for example, a hard drive, an array of hard drives, an optical drive, an array of optical drives, a flash drive, or any other tangible storage device. Further, the client system 102 can have one or more other types of tangible, machine-readable storage media, such as a memory 124, for example, which may comprise read-only memory (ROM) and/or random access memory (RAM). In exemplary embodiments, the client system 102 will generally include a network interface adapter 126, for connecting the client system 102 to a network 128, such as a local area network (LAN), a wide-area network (WAN), or another network configuration. The LAN can include routers, switches, modems, or any other kind of interface device used for interconnection.

Through the network interface adapter 126, the client system 102 can connect to a server 130. The server 130 may enable the client system 102 to connect to the Internet 132. For example, the client system 102 can access a search engine 134 connected to the Internet 132. In exemplary embodiments of the present invention, the search engine 134 may include generic search engines, such as GOOGLE™, YAHOO®, BING™, and the like. In other embodiments, the search engine 134 may be a specialized search engine that enables the client system 102 to access a specific database of documents provided by a specific on-line entity. For example, the search engine 134 may provide access to documents provided by a professional organization, governmental body, business entity, public library, and the like.

The server 130 can also have a storage array 136 for storing enterprise data. The enterprise data may provide a document resource to the client system 102 by including a plurality of stored documents, such as ADOBE® Portable Document file (PDF) documents, spreadsheets, presentation documents, word processing documents, database files, MICROSOFT® Office documents, Web pages, Hypertext Markup Language File (HTML) documents, eXtensible Markup Language (XML) documents, plain text documents, electronic mail files, optical character recognition (OCR) transcriptions of scanned physical documents, and the like. Furthermore, the documents may be structured or unstructured. As used herein, a set of “structured” documents refers to documents that have been related to one another by a tracking system that records the evolution of the documents from prior versions. However, in embodiments in which the documents are structured, the recorded relationship between documents may be ignored.

Those of ordinary skill in the art will appreciate that business networks can be far more complex and can include numerous servers 130, client systems 102, storage arrays 136, and other storage devices, among other units. Moreover, the business network discussed above should not be considered limiting as any number of other configurations may be used. Any system that allows a client system 102 to access a document resource, such as the storage array 136 or an external document storage, among others, should be considered to be within the scope of the present techniques.

In exemplary embodiments of the present invention, the memory 124 of the client system 102 may hold a document analysis tool 138 for analyzing electronic documents, for example, documents stored on the storage system 122 or storage array 136, documents available through the search engine site 134, or any other document resource accessible to the client system 102. Through the document analysis tool 138, the user may select a document, referred to herein as a “query document,” and initiate a provenance query. Pursuant to the provenance query, the document analysis tool identifies documents that are source documents relative to the query document. As used herein, a source document is a document that is textually similar to the query document, for example, a revision of the query document, a document that incorporates textual subject matter from the query document, and the like. The source documents may be ordered by time to determine the provenance of the query document.

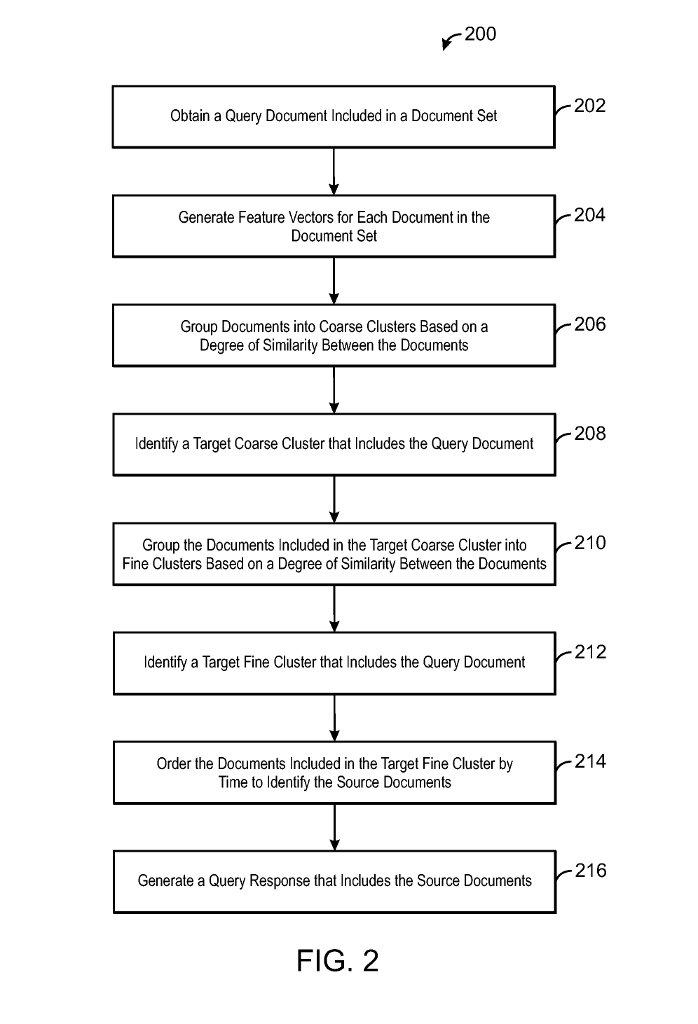

As discussed further below with regard to FIG. 2, the document analysis tool 138 may identify the source documents by segmenting a document set into clusters based on a textual similarity between the documents in the document set. In this way, each resulting cluster may include a group of documents that have similar textual content and may therefore be considered source documents. The cluster that includes the query document may be identified, and the documents in the identified cluster may then be ordered by time to identify the query document's provenance. The time associated with each document may be a time stamp assigned to the document by an operating system's file system. It is likely that the older documents in the cluster, as identified by the time stamp, contain textual subject matter that has been incorporated into the query document. Accordingly, the older documents in the cluster may be identified as source documents and the oldest document in the cluster may be identified as the original document. Additionally, to reduce the processing resources used to generate the clusters, the document analysis tool 138 may use a two-stage clustering method. A first clustering stage may use a coarse granularity to generate a number of coarse clusters. The coarse cluster that includes the query document may then be further segmented into fine clusters using a fine granularity.

FIG. 2 is a process flow diagram of a method of identifying the provenance of a document, in accordance with an exemplary embodiment of the present invention. The exemplary method described herein may be performed, for example, by the document analysis tool 138 operating on the client system 102. The method may be referred to by the reference number 200 and may begin at block 202, wherein a query document is obtained. The query document may be selected by a user that is interested in identifying the source documents that provided textual subject matter that has been incorporated into the query document. The query document may be included in a document set that includes a plurality of documents. The document set may be included in the storage array 132, the storage system 122, or any other document resource accessible to the client system 102 such as the search engine site 134. The document set may include any suitable type of documents, for example, MICROSOFT® Office documents, electronic mail files, plain text documents, HTML documents, ADOBE® Portable Document File (PDF) documents, Web pages, scanned OCR documents, and the like.

In some exemplary embodiments, the document set may include files that are co-located with the query file, for example, in the same file directory, disk drive, disk drive partition, and the like. The user may define the document set, for example, by selecting a particular file directory or disk drive. Furthermore, the user may define the document set as including files with a common file characteristic, for example, the same file type, the same file extension, a specified string of characters in the file name, files created after a specified data, and the like. In some embodiments, the document set may be defined automatically based on the location of the query document, the type of query document, and the like. For example, upon selecting a PDF document in a particular directory, the document set may be automatically defined as including all PDF documents in the same directory.

At block 204, a feature vector may be generated for each document in the document set, including the query document. The feature vector may be used to compare the textual content of the documents and identify similarities or dissimilarities between documents. The feature vector may be generated by scanning the document and identifying the individual terms or phrases, referred to herein as “tokens,” occurring in the document. Each time a token is identified in the document, an element in the feature vector corresponding to the token may be incremented. Each element in the feature vector may be referred to herein as a “token frequency.” Each feature vector may include a token frequency element for each token represented in the document set. The feature vector of a document may be represented by the following formula:

V_{D}^{tf-idf}:=(tf₁,tf₂, . . . , tf_{T})

In the above formula, V_{D} refers to the frequency with which the t^{th} term in the document set occurs in the document and T equals the total number of tokens in the document set.

In some exemplary embodiments, each token frequency of the feature vector is multiplied by a global weighting factor that corresponds with a characteristic of the entire document set. The same global weighting factor may be applied to the feature vector of each document in the document set. In some embodiments, the global weighting factor may be an inverse document frequency (idf), which is the inverse of the fraction of documents in the document set that contain a given token. In such embodiments, the resulting weighted feature vector may be represented by the following formula:

$${V}_{D}^{tf - idf} := ( {tf}_{1} log \frac{\vert U \vert}{{df}_{1}} , {tf}_{2} log \frac{\vert U \vert}{{df}_{2}} , … , {tf}_{T} log \frac{\vert U \vert}{{df}_{T}} )$$

In the above formula, V_{D}^{tf-idf} is the feature vector multiplied by the inverse document frequency, |U| equals the number of documents in the document set, and dfₜ is the number of documents in the document set that contain the t^{th} token. Additionally, each of the weighted token frequencies of the weighted feature vector may be normalized to have unit magnitude, for example, a magnitude between 0 and 1.

At block 206, the documents in the document set may be grouped into coarse clusters based on a degree of textual similarity between the documents. To determine the degree of textual similarity between the documents, a similarity value may be computed for each pair of feature vectors generated for the documents in the document set. To group the documents into coarse clusters, the feature vectors corresponding to the documents may be processed by a clustering algorithm that segments the documents in the document set into a plurality of coarse clusters based on the similarity value. In some exemplary embodiments, the similarity value may be a Cosine similarity computed according to the following formula:

$$s ( {D}_{i} , {D}_{j} ) := cos ( {V}_{{D}_{i}} , {V}_{{D}_{j}} ) = \frac{{V}_{{D}_{i}} \cdot {V}_{{D}_{j}}}{‖ {V}_{{D}_{i}} ‖ ‖ {V}_{{D}_{j}} ‖}$$

In the above formula, s(Rᵢ,Dⱼ) represents the similarity value for the documents Dᵢ and Dⱼ, V_{D}_{ₜ}·V_{D}_{ⱼ} is the dot product of the feature vectors corresponding to the documents Dᵢ and Dⱼ, and ∥V_{D}∥∥V_{D}∥∥ is the product of the magnitudes of the feature vectors corresponding to the documents Dᵢ and Dⱼ.

Any suitable clustering algorithm may be used to group the selected documents into coarse clusters, for example, a k-means algorithm, a repeated bisection algorithm, a spectral clustering algorithm, an agglomerative clustering algorithm, and the like. These techniques may be considered as either additive or subtractive. The k-means algorithm is an example of an additive algorithm, while a repeated-bisection algorithm may be considered as an example of a subtractive algorithm.

In a k-means algorithm, a number, k, of the documents may be randomly selected by the clustering algorithm. Each of the k documents may be used as a seed for creating a cluster and serve as a representative document, or “cluster head,” of the cluster until a new document is added to the cluster. Each of the remaining documents may be sequentially analyzed and added to one of the clusters based on a similarity between the document and the cluster head. Each time a new document is added to a cluster, the cluster head may be updated by averaging the feature vector of the cluster head with the feature vector of the newly added document.

In a repeated-bisection algorithm, the documents may be initially divided into two clusters based on dissimilarities between the documents, as determined by the similarity value. Each of the resulting clusters may be further divided into two clusters based on dissimilarities between the documents in each cluster. The process may be repeated until a final set of clusters is generated.

Furthermore, to generate the coarse clusters a coarse granularity, N, may be determined. The coarse granularity, N, represents an average cluster size, in other words, an average number of documents that may be grouped into the same coarse cluster by the clustering algorithm. The coarse granularity may be determined based on the number of documents in the document set and the expected processing time that may be used to generate the fine clusters during the second clustering stage, which discussed below in reference to block 210. For example, if the document set includes 15,000 documents, the coarse granularity, N, may be set to a value of 1000. In this hypothetical example, the clustering algorithm will generate 15 coarse clusters, and each coarse cluster may include an average of approximately 1000 documents. In some embodiments, the coarse granularity may be specified by a user. In some embodiments, the coarse granularity may be automatically determined by the clustering algorithm as a fraction of the number of documents in the document set and depending on the processing resources available to the client 102.

At block 208, a target coarse cluster may be identified. The target coarse cluster is the coarse cluster generated in block 206 that includes the query document. In some embodiments, the size of the target coarse cluster may be evaluated to determine whether the size of the target coarse cluster is approximately equal to the coarse granularity, N. Depending on the available processing resources of the client 102, a target coarse cluster that is too large may result in a long processing time during the generation of the fine clusters at block 210. Thus, if the coarse cluster includes a number of documents that is approximately two to five times greater than the specified coarse cluster granularity, N, then the block 206 may be repeated with a smaller granularity to reduce the size of the target coarse cluster. Blocks 208 and 210 may be iterated until the size of the target coarse cluster is approximately equal to or smaller that the originally specified coarse cluster granularity, N. After obtaining the target coarse cluster and verifying the size of the target coarse cluster, the process flow may advance to block 210.

At block 210, the documents included in the target coarse cluster may be grouped into fine clusters based on the degree of textual similarity between the documents. The generation of the fine clusters may be accomplished using the same techniques described above in relation to block 206, using a fine granularity, n. The fine granularity, n, represents an average size of the fine clusters, in other words, an average number of documents that may be grouped into each fine cluster by the clustering algorithm. The fine cluster size, n, may be specified based on an estimated number of documents that may be expected to be derivatives of the query document. For example, the fine granularity, n, may be specified based on an estimated number of revisions of the query document or an estimated number of documents that incorporate subject matter from the query document. For example, if the query document is a research paper, it may be estimated that the number of derivative documents may be less than 50. Thus, in this hypothetical example, the fine granularity, n, may be specified as 50. In another hypothetical example, the query document may be a financial statement. In this case, it may be expected that there exists a greater number of derivative documents, for example, 100 to 150. In other exemplary embodiments, the fine granularity may be five to ten documents. In some embodiments, the fine granularity may be specified by a user. In other embodiments, the fine granularity may be automatically determined by the clustering algorithm using a set of heuristic rules based on document type.

The resulting fine clusters may include documents that have a high degree of similarity with each other. The high degree of similarity of the documents in each fine cluster may indicate a high degree of likelihood that newer documents in the target fine cluster may have been derived from the older documents. In other words, it is likely that the each document in the fine cluster is a source document relative to any newer document in the fine cluster. After generating the fine clusters, the process flow may advance to block 212.

At block 212, a target fine cluster may be identified. The target fine cluster is the fine cluster generated in block 210 that includes the query document. Thus, the target fine cluster may include most or all of the documents that are similar enough to the query document to be considered a source document. In some exemplary embodiments, the size of the target fine cluster may be evaluated to determine whether the size of the target fine cluster is approximately equal to the fine granularity, n. If the target fine cluster that is too large this may indicate that a number of documents in the fine cluster are not source documents. Thus, if the fine cluster includes a number of documents that is approximately two to five times greater than the specified fine cluster granularity, n, block 210 may be repeated with a smaller granularity to reduce the size of the target fine cluster. Blocks 210 and 212 may be iterated until the size of the target fine cluster is approximately equal to or smaller that the originally specified fine cluster granularity, n. After obtaining the target fine cluster and verifying the size of the target fine cluster, the process flow may advance to block 214.

At block 214, the documents in the target fine cluster may be ordered according to time. The document order may be used to identify source documents that were created or modified at an earlier time compared to the query document. The time associated with a document may be determined from date and time information included in metadata associated with the document. For example, the time associated with a document may include a date and time that the document was created, last modified, or the like. Those documents associated with a later time compared to the query document may be considered to be newer versions of the query document. Thus, documents with a later time compared to the query document may be ignored. Those documents with an earlier time compared to the query document may be flagged or otherwise identified by the data analysis tool as source documents of the query document. The earliest document in the target fine cluster may be identified by the data analysis tool as an original document. In some exemplary embodiments, the documents in the target fine cluster may be ordered according to other information included in the metadata, such as document author, version number, document type, and the like. For example, in some embodiments, the documents in the target fine cluster may be grouped based on author. The documents associated with a particular author may be arranged according to time to generate a chain of provenance for each individual author.

In some exemplary embodiments, the process described in blocks 202 to 214 may be repeated with one of the documents in the target fine cluster used as a new query document. Upon selecting the new query document and initiating a new provenance query, the documents of the target coarse cluster previously identified at block 208 may be re-grouped into new fine clusters using the new query document. In this way, the new target fine cluster may include a new sub-set of documents, from which the provenance of the new query document may be determined. Furthermore, to increase the likelihood that the new target fine cluster will include documents highly related to the new query document, the feature vectors for each document in the target coarse cluster may be re-computed. For example, the token frequencies of each feature vector may be weighted more heavily for those tokens of interest that occur frequently in the new query document. In this way, the clustering algorithm will be more likely to treat the new query document as the cluster head, which may result in a new grouping of documents around the new query document. In some embodiments, the document used as the new query document may be selected by the user. In other embodiments, the process described in block 202 to 214 may be iteratively repeated for each one of the documents in the target fine cluster to generate a chain of related documents. For example, multiple documents in the target fine cluster may be identified as corresponding with the same source document, which may indicate that the documents are derivatives of the same source document.

At block 216, the document analysis tool may generate a query response that includes the source documents included in the target fine cluster and any additional secondary source documents identified by repeated iterations of the clustering algorithm. The query response may be used to generate a visual display viewable by the user, for example, a graphical user interface (GUI) generated on the display 114 (FIG. 1). In some exemplary embodiments, the visual display may include a listing of the documents included in the target fine cluster ordered by time. The visual display may also include a variety of information about the source documents, for example, date created, date last modified, file location, file author, and the like. In some exemplary embodiments, the visual display may also include some or all of the textual content of one or more of the source documents. In some exemplary embodiments, further processing may be performed to determine relationships between documents. For example, data mining may be performed on the file paths associated with documents in the target fine cluster to identify one or more project names associated with one or more of the documents. The project names may be used to determine, for example, whether two or more projects were merged into a single document.

The visual display may also enable the user to select a specific one of the source documents to, for example, initiate another provenance query using the selected document, view the contents of the selected document in a document viewer, and the like. In some exemplary embodiments, the visual display may represent the source documents with file icons that are spatially organized based on the identified relationships between the documents. For example, arrows between the file icons may be used to identify the document evolution, documents mergers, and the like.

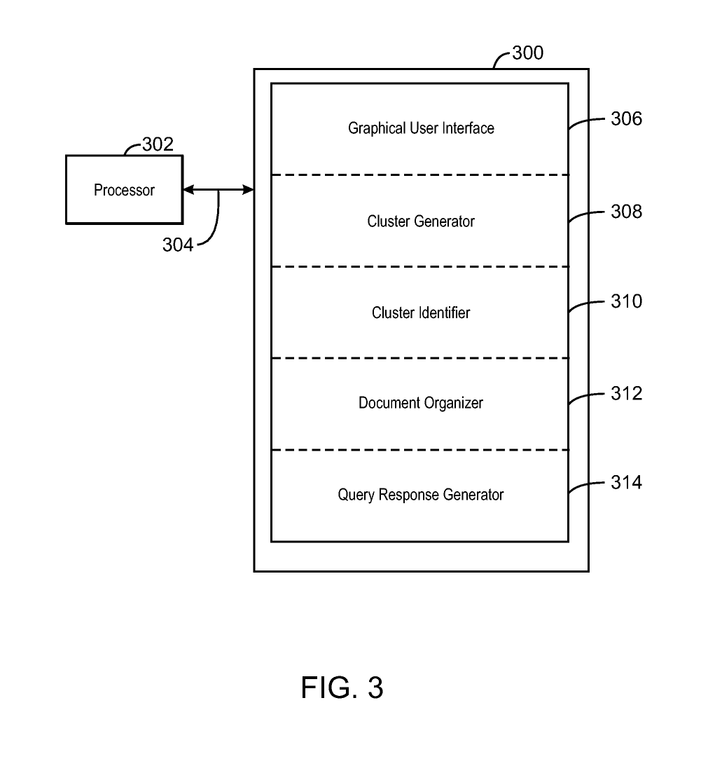

FIG. 3 is a block diagram showing a tangible, machine-readable medium that stores code adapted to determine the provenance of a document, in accordance with an exemplary embodiment of the present invention. The tangible, machine-readable medium is generally referred to by the reference number 300. The tangible, machine-readable medium 300 can comprise RAM, a hard disk drive, an array of hard disk drives, an optical drive, an array of optical drives, a non-volatile memory, a USB drive, a DVD, or a CD, among others. Further, the tangible, machine-readable medium 300 can comprise any combinations of media. In one exemplary embodiment of the present invention, the tangible, machine-readable medium 300 can be accessed by a processor 302 over a computer bus 304.

As shown in FIG. 3, the various exemplary components discussed herein can be stored on the tangible, machine-readable medium 300 and included in one or more instruction modules. As used herein, a “module” is a group of processor-readable instructions configured to instruct the processor to perform a particular task. For example, a first module 306 on the tangible, machine-readable medium 300 may store a GUI configured to enable a user to select a query document from among a plurality of documents in a document set and initiate a provenance query. A second module 308 can include a cluster generator configured to group the plurality of documents into a plurality of fine clusters based on a textual similarity between each of the plurality of documents. Additionally, the cluster generator may be configured to employ a two-stage clustering algorithm as discussed above with reference to FIG. 2. A third module 310 can include a cluster identifier configured to identify a target fine cluster within the plurality of fine clusters, the target fine cluster including the query document. A fourth module 312 can include a document organizer configured to order the documents included in the target fine cluster by time. A fifth module 314 can include a query response generator configured to generate a query response that includes the source documents, including any secondary sources.

Although shown as contiguous blocks, the modules can be stored in any order or configuration. For example, if the tangible, machine-readable medium 300 is a hard drive, the software components can be stored in non-contiguous, or even overlapping, sectors. Additionally, one or more modules may be combined in any suitable manner depending on design considerations of a particular implementation. Furthermore, modules may be implemented in hardware, software, or firmware.

What is claimed is:

1. A method of identifying a provenance of a document, comprising:
obtaining a query document from a document set comprising a plurality of documents;
grouping the plurality of documents into a plurality of fine clusters based on a textual similarity between each of the plurality of documents;
identifying a target fine cluster within the plurality of fine clusters, the target fine cluster including the query document;
ordering the documents included in the target fine cluster based, at least in part, on metadata associated with each of the documents to identify a source document; and
generating a query response that includes the source document.

2. The method of claim 1, wherein grouping the plurality of documents into a plurality of fine clusters comprises:
grouping the plurality of documents into a plurality of coarse clusters based on a textual similarity between the plurality of documents;
identifying a target coarse cluster within the plurality of coarse clusters, the target coarse cluster including the query document; and
grouping the documents in the target coarse cluster into the plurality of fine clusters.

3. The method of claim 1, wherein grouping the plurality of documents into a plurality of fine clusters comprises generating a feature vector for each of the plurality of documents, the feature vector comprising a token frequency for each token in the document set.

4. The method of claim 3, comprising multiplying each token frequency of the feature vector by a weighting factor corresponding to a number of documents in the document set that include the corresponding token.

5. The method of claim 1, wherein grouping the plurality of documents into the plurality of fine clusters comprises computing a cosine similarity for each pair of documents in the plurality of documents.

6. The method of claim 1, wherein grouping the plurality of documents into a plurality of fine clusters comprises using a two-stage clustering algorithm, wherein a first clustering stage uses a coarse granularity and a second clustering stage uses a fine granularity.

7. The method of claim 6, wherein the fine granularity is determined based on a number of expected source documents.

8. The method of claim 1, comprising repeating the second clustering stage with a finer granularity if a number of documents in the target fine cluster is approximately two to five times greater than the specified fine granularity.

9. The method of claim 1, comprising:
obtaining the source document that is included in the target fine cluster;
grouping the plurality of documents into a second plurality of fine clusters based on a textual similarity between the plurality of documents;
identifying a second target fine cluster within the second plurality of fine clusters, the second target fine cluster including the source document; and
ordering the documents included in the second target fine cluster based, at least in part, on metadata associated with each of the documents to identify a secondary source document corresponding with the source document.

10. A computer system, comprising:
a processor that is adapted to execute machine-readable instructions; and
a storage device that is adapted to store data, the data comprising a plurality of documents and instruction modules that are executable by the processor, the instruction modules comprising:
a graphical user interface (GUI) configured to enable a user to select a query document from the plurality of documents and initiate a provenance query;
a cluster generator configured to group the plurality of documents into a plurality of fine clusters based on a textual similarity between the plurality of documents;
a cluster identifier configured to identify a target fine cluster within the plurality of fine clusters, the target fine cluster including the query document;
a document organizer configured to order the documents included in the target fine cluster based, at least in part, on metadata associated with each of the documents and identify a source document; and
a query response generator configured to generate a query response that includes the source document.

11. The computer system of claim 10, wherein the cluster generator is configured to perform a two-stage clustering process for generating the fine clusters, wherein:
a first clustering stage comprises grouping the plurality of documents into a plurality of coarse clusters based on a textual similarity between the plurality of documents; and
a second clustering stage comprises grouping the documents in a target coarse cluster into the plurality of fine clusters; wherein the target coarse cluster includes the query document.

12. The computer system of claim 10, wherein the query response includes a list of documents that are source documents relative to the query document and the GUI is configured to generate a visual display of the list of documents.

13. The computer system of claim 10, wherein the cluster generator is configured to identify secondary source documents for the source document included in the target fine cluster.

14. The computer system of claim 10, wherein the cluster generator is configured to generate a feature vector for each of the plurality of documents, the feature vector comprising a token frequency for each token in the plurality of documents, wherein each token frequency is weighted by a weighting factor corresponding to a number of documents in the plurality of documents that include the corresponding token.

15. The computer system of claim 10, wherein the plurality of documents comprise documents in an electronic mail database.

16. The computer system of claim 10, wherein the plurality of documents comprise Web pages identified by an internet search engine.

17. A tangible, computer-readable medium, comprising code configured to direct a processor to:
enable a user to select a query document from among a plurality of documents and initiate a provenance query;
group the plurality of documents into a plurality of fine clusters based on a textual similarity between the plurality of documents;
identify a target fine cluster within the plurality of fine clusters, the target fine cluster including the query document;
order the documents included in the target fine cluster according to metadata associated with each of the documents and identify a source document; and
generate a query response that includes the source document.

18. The tangible, computer-readable medium of claim 17, comprising code configured to direct a processor to perform a two-stage clustering process for generating the fine clusters, wherein:
a first clustering stage comprises grouping the plurality of documents into a plurality of coarse clusters based on a textual similarity between the plurality of documents; and
a second clustering stage comprises grouping the documents in a target coarse cluster into the plurality of fine clusters; wherein the target coarse cluster includes the query document.

19. The tangible, computer-readable medium of claim 17, comprising code configured to direct a processor to generate a feature vector for each of the plurality of documents, the feature vector comprising a token frequency for each token in the plurality of documents, wherein each token frequency is weighted by a weighting value corresponding to a number of documents in the plurality of documents that include the corresponding token.

20. The tangible, computer-readable medium of claim 17, comprising code configured to direct a processor to determine a fine granularity based on a document type of the query document.
